(19) United States
(12) Patent Application Publication
(10) Pub. No.: US 2025/0065823 A1
(43) Pub. Date: Feb. 27, 2025

(54) DECORATIVE FILM AND VEHICLE WITH A DECORATIVE FILM

(71) Applicants: Bayerische Motoren Werke Aktiengesellschaft, München (DE); E INK CORPORATION, Billerica, MA (US)

(72) Inventors: Stella CLARKE, Garching (DE); Dirk MUELLER-STOLZ, Muenchen (DE); Jennifer B. LAMPRON, Newton, NH (US); Eric J. DUCHAINE, Hampstead, NH (US)

(21) Appl. No.: 18/725,539

(22) PCT Filed: Dec. 29, 2022
(86) PCT No.: PCT/EP2022/088006

§ 371 Date: Jun. 28, 2024

(30) Foreign Application Priority Data
Jan. 1, 2022 (DE) 10 2022 000 005.9

(51) Int. Cl. B60R 13/04; B32B 3/26; B60J 11/00; G02F 1/1343

(52) U.S. Cl. CPC B60R 13/04; B32B 3/266; B60J 11/00; G02F 1/134309; B32B 2307/416; B32B 2451/00; B32B 2457/202; B32B 2605/08

(57) ABSTRACT

A decorative film (2) for application to a surface (10) having non-planar surface regions (17, 18), with a decorative layer (24), is characterised in that the inherently stiff decorative film (2) is provided with a plurality of compression regions (4, 4′, 4″) and/or expansion regions (5, 5′, 5″), in that each compression region (4, 4′, 4″) has a star-shaped or diamond-shaped compression element (40, 40′, 40″) which is formed by a plurality of compression slits (42, 43, 44, 45, 46, 47; 42′, 43′, 44′, 45′, 46′, 47′) extending in a star shape or designed in a diamond shape that penetrate the decorative film (2) in the thickness direction (D), and in that each expansion region (5, 5′, 5″) has an expansion element (50, 50′, 50″) which is formed by at least one expansion slit (52, 54) that penetrates the decorative film (2) in the thickness direction (D).

### TECHNICAL FIELD

The invention relates to a decorative film according to the preamble of patent claim 1. It further relates to a vehicle, in particular a motor vehicle, the body skin of which is provided with such a decorative film on the outside, at least in certain regions.

### BACKGROUND OF THE INVENTION

Automotive customers often want to be able to customise and personalise the exterior of their vehicles. Although this has been possible up to now using customised vehicle paintwork or partial paintwork or by film-wrapping the outer body skin, such individual vehicle designs can only be changed with considerable effort and, in particular, not based on the situation. In the case of wrapping with a decorative film, the decorative film must be highly flexible, stretchable and compressible, which is difficult with thicker and stiffer decorative films. It may also be desirable to flexibly adapt the external appearance of the vehicle to a specific driving purpose-serious and restrained for use as a business vehicle or brightly coloured for surfing holidays at the beach.

### PRIOR ART

It is already known to cover curved and cambered surfaces with highly flexible, stretchable and compressible decorative films; up to now this has not been possible with stiffer films, such as for example wood veneer or e-paper films. It is also known to provide display devices on the vehicle body that operate using e-paper technology and can be switched between different visual appearances, but up to now this has only been possible on flat surfaces of the vehicle body.

### DESCRIPTION OF THE INVENTION

The object of the present invention is to specify a decorative film that can be flexibly adapted to any three-dimensionally shaped surfaces. A further object is to specify a motor vehicle with at least one such decorative film.

The part of the object concerned with the decorative film is solved by the features of patent claim 1.

A decorative film which is provided for application to a surface having non-planar, for example curved and/or cambered, surface regions and which is provided with a decorative layer, is characterised in that the inherently stiff decorative film is provided with a plurality of compression regions and/or expansion regions, in that each compression region has a star-shaped or diamond-shaped compression element which is formed by a plurality of compression slits extending in a star shape or designed in a diamond shape that penetrate the decorative film in the thickness direction, and in that each expansion region has an expansion element which is formed by at least one expansion slit that penetrates the decorative film in the thickness direction.

An “inherently stiff” decorative film is not to be understood here as a rigid decorative film, but rather as a decorative film with limited flexibility in its initial state, which can be bent in one direction but which cannot be bent in two different directions, i.e. around two different axes, at the same time. The bendability of the decorative film in its initial state may also be limited to larger bending radii and not permit tight bending radii.

### Advantages

The design of the decorative film according to the invention with a pattern of individual slits penetrating the decorative film in the thickness direction leads to the fact that the unslit, inherently almost stiff decorative film becomes flexible in three dimensions due to the slit pattern of the invention. Slitting is preferably carried out using laser beams, a cutting plotter or other cutters so that the individual slits are extremely narrow and therefore barely visible when the decorative film is in the flat state.

The compression regions can be compressed due to their star-shaped or diamond-shaped structure, which is necessary, for example, if the decorative film has to adapt locally to a depression or indentation in the substrate, such as for example the outer skin of the vehicle body. The tapering surface regions of the decorative film that remain between the star-shaped compression slits can converge or even overlap, bridging the respective compression slit, so that the decorative film is contracted at this point, i.e. its area is compressed.

In the expansion regions, the decorative film can be stretched in a direction transverse, for example at right angles, to the longitudinal direction of the at least one expansion slit, i.e. its area is expanded, so that the width of such an expansion slit increases, at least in its central region.

Further preferred and advantageous design features of the decorative film according to the invention form the subject matter of dependent claims 2 to 14.

The compression regions and the expansion regions are preferably distributed over the area of the decorative film in such a way that at least one expansion region is provided between two neighbouring compression regions. This alternating arrangement of compression regions and expansion regions ensures that the decorative film is particularly flexible.

It is further preferably provided that neighbouring compression elements form at least one pair of compression slits converging towards one another, between the free ends of which an unslit, intact bridge region of the decorative film is provided, and that at least one expansion slit is provided parallel to each pair of converging compression slits and laterally spaced apart therefrom, the pair of converging compression slits together with the at least one expansion slit forming an expansion element of the expansion region. The converging compression slits preferably have a common centre axis in their longitudinal direction, so that the at least one expansion slit is aligned parallel to the centre axis of the two converging compression slits. If each compression region is surrounded by a number of expansion regions corresponding to the number of its rays, i.e. the number of compression slits emanating from its centre, the decorative film can be deformed three-dimensionally in almost any surface-normal direction.

The at least one expansion slit preferably extends only in the region of the free end of a respective compression slit of the pair of converging compression slits, preferably parallel thereto. This leaves sufficient space between the individual expansion slits and compression slits to ensure a stable surface connection between the remaining unslit areas of the decorative film, provided that the decorative film is sufficiently flexible.

In an alternative advantageous further development of the decorative film according to the invention, the at least one expansion slit extends up to half the length, preferably only along the front third, of a respective compression slit of the pair of converging compression slits parallel thereto. The flexibility of the decorative film is significantly improved while still maintaining sufficient durability and reliability.

In all variants of the invention, it is advantageous if the at least one expansion slit has longitudinal edges that are parallel to one another when the decorative film is laid flat and thus has a constant slit width.

Also advantageous is an embodiment of the invention which can be combined with other embodiments, wherein the expansion element has a first expansion slit and a second expansion slit that are provided at a lateral distance from the pair of converging compression slits on two sides of the pair of converging compression slits facing away from each other, preferably parallel thereto. These expansion slits provided on both sides of the pair of converging compression slits increase the stretchability of the decorative film and thus improve its flexible properties.

Also advantageous is an embodiment of the invention which can also be combined with other embodiments, wherein, when the decorative film is laid flat, the compression slits which extend away from one another in a star shape each have a slit width that decreases from the centre of the compression element towards the respective free end of the relevant compression slit, so that the respective compression slit tapers towards its free end. This achieves high surface compressibility without the edges of the adjacent unslit surface areas overlapping.

Preferably, the star-shaped compression element has at least three compression slits which extend away from one another in a star shape. Further preferred, the star-shaped compression element has five, six or seven compression slits which extend away from one another in a star shape, thereby further increasing the flexibility of the decorative film.

According to a further, particularly preferred embodiment of the invention, the decorative film has a plurality of star-shaped compression elements with different numbers of compression slits that extend away from one another in a star shape. Such a decorative film has regions of varying flexibility and can therefore be adapted to substrates having different degrees of three-dimensional shaping.

It is particularly advantageous if the number of expansion elements per unit area in those regions of the decorative film that can be adapted to a convex surface region is greater, the smaller the radius of curvature of the convex surface region is.

It is also advantageous if the number of compression elements per unit area in those regions of the decorative film that can be adapted to a concave surface region is greater, the smaller the radius of curvature of the concave surface region is.

Preferably, the light reflection properties or light transmission properties of the decorative layer of the decorative film can be changed by applying an electrical voltage.

The decorative film preferably has a first electrode layer, a second electrode layer and a decorative layer arranged between the two electrode layers, the light reflection properties or light transmission properties of which can be changed by applying an electrical voltage. Although the slitting of the decorative film in the thickness direction penetrates the electrode layers and the decorative layer, the electrode layers do not lose their continuous electrical conductivity, so that the decorative film does not lose its property of being able to switch electrically between two colour states because the remaining surface regions of the decorative film, including the electrode layer regions of the respective electrodes remaining after slitting, are still connected to one another.

Although the star-shaped compression slits—at least in some of the compression elements of the decorative film—meet in a common centre and are connected to one another there, it is particularly advantageous if, in other compression elements, the inner ends of the compression slits which extend away from one another in a star shape are spaced apart from one another in the centre of the compression element in order to achieve better electrical conductivity.

The decorative layer is preferably a smart glass LCD layer that is switchable between transparent and opaque, or an e-paper layer that is switchable between two colours. However, the decorative layer can also be a wood veneer layer, for example.

The part of the object concerned with the vehicle is solved according to claim 15 by a vehicle, in particular a motor vehicle, having a vehicle body and a vehicle interior at least partially surrounded thereby, the vehicle body being provided with a non-planar outer body skin, for example having curved and/or cambered surface regions on the outside of the vehicle, and/or the vehicle interior having interior components that are each provided with a non-planar surface, for example having curved and/or cambered surface regions on the inside of the vehicle. According to the invention, the non-planar surface regions inside the vehicle and/or the non-planar surface regions outside the vehicle are provided, at least in parts, with a decorative film according to any of the preceding claims which has a decorative layer, the light reflection properties or light transmission properties of which can preferably be changed. Providing the decorative layer on the outside of the vehicle or inside the vehicle, for example, opens up a wide range of new design possibilities for three-dimensionally curved free-form surfaces in or on the vehicle.

If the decorative film is configured as an e-paper film and this is provided at least in some regions on the outer body skin, the visual appearance of such a film-wrapped outer body skin can be varied by switching the state of the e-paper film. For example, with coloured e-paper film, it is possible to change the body colour.

Preferred embodiments of the invention with additional design details and further advantages are described and explained in more detail below with reference to the attached drawings.

### BRIEF DESCRIPTION OF DRAWINGS

These show the following:

FIG. 1A motor vehicle with a vehicle body having an outer body skin;

FIG. 2A schematic representation of the structure of an e-paper display device in an enlarged longitudinal section;

FIG. 3A section of a surface of a three-dimensionally shaped decorative film according to the invention with compression regions and expansion regions;

FIG. 4 An enlarged compression region, and

FIG. 5 An enlarged expansion region.

### DESCRIPTION OF PREFERRED EMBODIMENTS

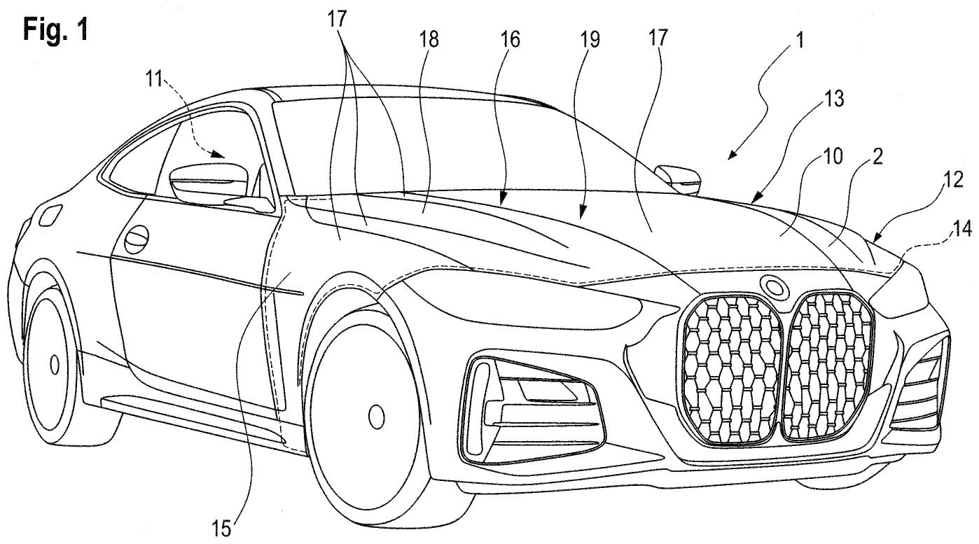

FIG. 1 shows a motor vehicle 1 with a vehicle body 12 having an outer body skin 10 and a vehicle interior 11 at least partially surrounded thereby. In the region of the front bonnet 13 and the front wings 14, 15, the outer body skin 10 is wrapped with a sandwich film 19 having a below-described decorative film 2, as shown schematically by dashed lines. In this region, the outer body skin 10 forms a non-planar surface 16 with convex portions 17 and concave portions 18.

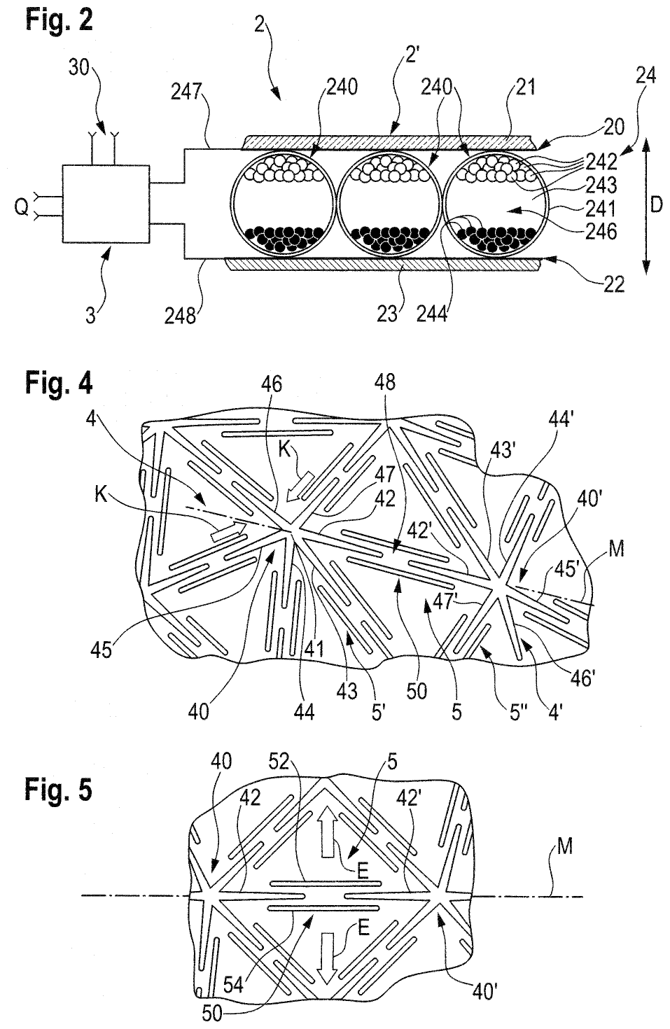

FIG. 2 is an enlarged longitudinal section of a representation of the structure of an e-paper film 2′ known per se, which forms a decorative film 2 according to the invention. The e-paper film 2′ has a first flat (upper) transparent electrode layer 20 with a transparent cover layer 21, a second flat (lower) electrode layer 22 with a supporting layer 23 and a display layer arranged between the two electrode layers 20, 22, which forms the changeable decorative layer 24.

The first electrode layer 20 is connected via a first electrically conductive connection 247 to an electrical control device 3 and the second electrode layer 22 is also connected via a second electrically conductive connection 248 to the control device 3. The control device 3 is supplied with electrical energy from an electrical power source Q. The control device 3 also receives control signals via control lines 30.

The display layer forming the decorative layer 24 of the e-paper film 2′ is provided with a plurality of display spheres 240 configured as microcapsules. Each of the display spheres 240 has a transparent housing wall 241 that encloses an interior 246 of the display sphere 240. The interior 246 contains a plurality of first pigments 242 of a first colour (here white) and a plurality of second pigments 244 of a second colour (here black) which are surrounded by a transparent fluid 243, the black pigments 244 usually being positively charged and the white pigments 242 negatively charged.

When a positive or negative electric field is activated by applying a voltage to the electrodes 20, 22, the black pigments 244 and the white pigments 242 move to the respective opposite electrodes 20, 22. The pigment particle quantity that moves to the upper (transparent) electrode 20 is visible to the observer as a black or white dot. Further developments of this shown e-paper film 2′ with a plurality of different display spheres containing coloured pigments instead of white pigments 242 are able to display colours.

The control device 3 provides the electrodes 20, 22 with an electrical switching signal with the corresponding polarity in order to switch the display spheres 240 for example from black to white or vice versa. If the display layer of the e-paper film 2′ is able to display different colours, the control device 3 is able to control the display spheres 240 so that the e-paper film 2′ displays a colour desired by the user.

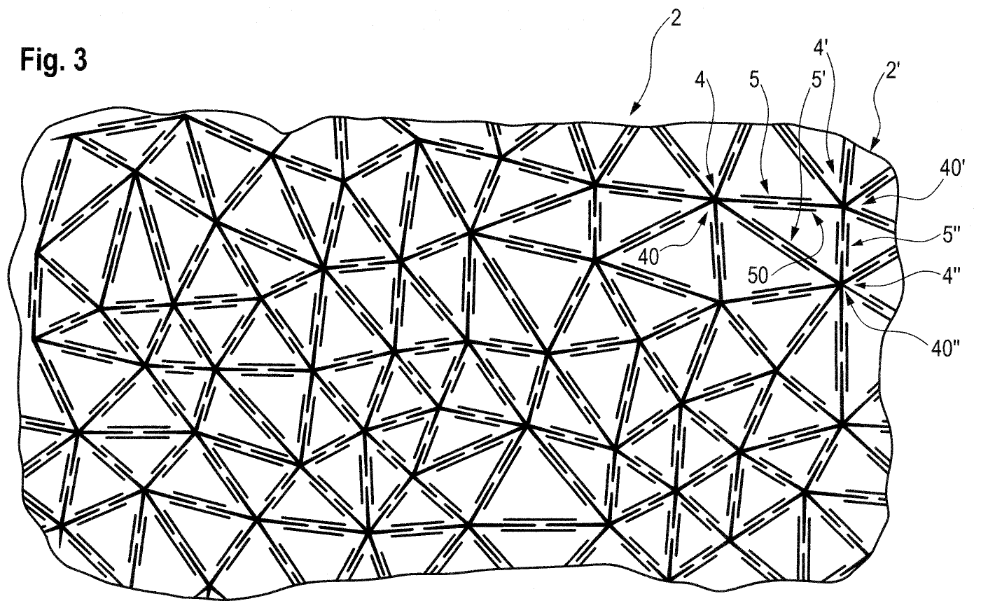

FIG. 3 shows a section of a surface of the decorative film 2, for example the e-paper film 2′, according to the invention. This decorative film 2 is provided with a plurality of compression regions 4, 4′, 4″ and expansion regions 5, 5′, 5″. Each compression region 4, 4′, 4″ has a star-shaped compression element 40, 40′, 40″, shown in detail in FIG. 4, which is formed by a plurality of compression slits 42, 43, 44, 45, 46, 47; 42′, 43′, 44′, 45′, 46′, 47′ that extend in a star shape from a common centre 41 and penetrate the decorative film 2 in the thickness direction D. When the decorative film 2 is laid flat as shown in FIG. 4, the compression slits 42, 43, 44, 45, 46, 47; 42′, 43′, 44′, 45′, 46′, 47′ each have a slit width that decreases from the centre 41 of the compression element 40 towards the respective free end of the relevant compression slit 42, 43, 44, 45, 46, 47; 42′, 43′, 44′, 45′, 46′, 47′, so that the respective compression slit 42, 43, 44, 45, 46, 47; 42′, 43′, 44′, 45′, 46′, 47′ tapers towards its free end.

Neighbouring compression elements 40, 40′ each form a pair of compression slits 42, 42′ converging towards one another. The free ends of these converging compression slits 42, 42′ do not touch each other, but are spaced apart and leave an unslit bridge region 48 between their free ends, in which the decorative film 2 is intact and electrically functional in the case of an e-paper film 2′. These converging compression slits 42, 42′ have a common centre axis M in their longitudinal extension.

An expansion element 50 forming the expansion region 5 is always provided between two neighbouring compression elements 40, 40′. For this purpose, as shown in FIG. 5, a first expansion slit 52 and a second expansion slit 54, which are aligned parallel to each other, extend parallel to each pair of converging compression slits 42, 42′ and laterally spaced apart therefrom on two sides of the pair of converging compression slits 42, 42′ facing away from each other. When the decorative film 2 is laid flat, the respective expansion slit 52, 54 has longitudinal edges parallel to one another, as shown in FIG. 5, and thus has a constant slit width.

The expansion slits 52, 54 also penetrate the decorative film 2 in the thickness direction D. Thus, in the case of an e-paper film 2′, both the compression slits 42, 43, 44, 45, 46, 47; 42′, 43′, 44′, 45′, 46′, 47′ and the expansion slits 52, 54 are cut locally through the cover layer 21, the first electrode layer 20, the display layer 24, the second electrode layer 22 and the supporting layer 23.

The expansion slits 52, 54, which run parallel to the common centre axis M of the compression slits 42, 42′, extend along the front third, or up to half, of the longitudinal extension of the respective associated compression slit 42, 42′ pointing towards the free end.

If a tensile force is applied to the decorative film 2 in the film surface, which acts transversely, for example at right angles, to the longitudinal extension of an expansion slit 52, 54 (as symbolically shown by the arrows E in FIG. 5), the opening width of the expansion slit 52, 54, i.e. its breadth, increases, causing the decorative film 2 in this region to stretch locally transversely to the longitudinal extension along the common centre axis M.

If a compressive force or shear force is applied to the decorative film 2 in the film surface, which acts towards the centre 41 of the compression element 40 (as symbolically shown by the arrows K in FIG. 4), the opening width of at least one compression slit 42, 42′ is reduced, so that the decorative film 2 is locally compressed in this region.

The invention is not limited to the above embodiment, which merely serves as a general explanation of the core idea of the invention. Rather, within the scope of protection, the device according to the invention can also be implemented in embodiments other than those described above. In particular, the device can have features which are a combination of the respective individual features of the claims.

Reference numbers in the claims, the description and the drawings are merely intended to facilitate understanding of the invention and are not intended to limit the scope of protection.

### LIST OF REFERENCE NUMBERS

1 Motor vehicle
2 Decorative film
2′ E-paper film
3 Control device
4 Compression region
4′ Compression region
4″ Compression region
5 Expansion region
5′ Expansion region
5″ Expansion region
10 Outer body skin
11 Vehicle interior
12 Vehicle body
13 Bonnet
14 Wing
15 Wing
16 Non-planar surface
17 Convex portion of 10
18 Concave portion of 10
19 Sandwich film
20 First flat (upper) transparent electrode layer
21 Cover layer
22 Second flat (lower) transparent electrode layer
23 Supporting layer
24 Decorative layer
30 Control lines
40 Compression element
40′ Compression element
40″ Compression element
41 Centre
42 Compression slit
42′ Compression slit
43 Compression slit
43′ Compression slit
44 Compression slit
44′ Compression slit
45 Compression slit
45′ Compression slit
46 Compression slit
46′ Compression slit
47 Compression slit
47′ Compression slit
48 Unslit bridge region
50 Expansion element
52 Expansion slit
54 Expansion slit
240 Display sphere
241 Transparent housing wall
242 First pigments
243 Transparent fluid
244 Second pigments
246 Interior space
247 First electrically conductive connection
248 Second electrically conductive connection
D Thickness direction
E Arrow (stretching)
K Arrow (compressing)
M Centre line
Q Electrical power source

1. Decorative film (2) for application to a surface (10) having non-planar surface regions (17, 18), with a decorative layer (24),
characterised in that
the inherently stiff decorative film (2) is provided with a plurality of compression regions (4, 4′, 4″) and/or expansion regions (5, 5′, 5″),
each compression region (4, 4′, 4″) has a star-shaped or diamond-shaped compression element (40, 40′, 40″) which is formed by a plurality of compression slits (42, 43, 44, 45, 46, 47; 42′, 43′, 44′, 45′, 46′, 47′) that extend in a star shape or are designed in a diamond shape and penetrate the decorative film (2) in the thickness direction (D), and
each expansion region (5, 5′, 5″) has an expansion element (50, 50′, 50″) which is formed by at least one expansion slit (52, 54) that penetrates the decorative film (2) in the thickness direction (D).

2. Decorative film according to claim 1,
characterised in that
the compression regions (4, 4′, 4″) and the expansion regions (5, 5′, 5″) are distributed over the area of the decorative film (2) in such a way that at least one expansion region (5, 5′, 5″) is provided between two neighbouring compression regions (4, 4′, 4″).

3. Decorative film according to claim 1 or 2,
characterised in that
neighbouring compression elements (40, 40′, 40″) form at least one pair of compression slits (42, 42′) converging towards one another, between the free ends of which an unslit, intact bridge region (48) of the decorative film (2) is provided, and at least one expansion slit (52, 54) is provided parallel to each pair of converging compression slits (42, 42′) and laterally spaced apart therefrom, the pair of converging compression slits (42, 42′) together with the at least one expansion slit (52, 54) forming the expansion element (50) of the expansion region (5, 5′, 5″).

4. Decorative film according to claim 3,
characterised in that
the at least one expansion slit (52, 54) extends only in the region of the free end of a respective compression slit (42, 42′) or up to half the length, preferably only along the front third, of a respective compression slit (42, 42′) of the pair of converging compression slits (42, 42′) parallel thereto.

5. Decorative film according to any of the preceding claims,
characterised in that
the at least one expansion slit (52, 54) has longitudinal edges that are parallel to one another when the decorative film (2) is laid flat and thus has a constant slit width.

6. Decorative film according to any of the preceding claims,
characterised in that
the expansion element (50) has a first expansion slit (52) and a second expansion slit (54) which are provided at a lateral distance from the pair of converging compression slits (42, 42′) on two sides of the pair of converging compression slits (42, 42′) facing away from each other, preferably parallel thereto.

7. Decorative film according to any of the preceding claims,
characterised in that
when the decorative film (2) is laid flat, the compression slits (42, 43, 44, 45, 46, 47; 42′, 43′, 44′, 45′, 46′, 47′) which extend away from one another in a star shape each have a slit width that decreases from the centre (48) of the compression element (40, 40′) towards the respective free end of the relevant compression slit (42, 43, 44, 45, 46, 47; 42′, 43′, 44′, 45′, 46′, 47′), so that the respective compression slit (42, 43, 44, 45, 46, 47; 42′, 43′, 44′, 45′, 46′, 47′) tapers towards its free end.

8. Decorative film according to any of the preceding claims,
characterised in that
the star-shaped compression element (40, 40′, 40″) has at least three, preferably five, six or seven, compression slits which extend away from one another in a star shape.

9. Decorative film according to any of the preceding claims,
characterised in that
the decorative film (2) has a plurality of star-shaped compression elements (40, 40′, 40″) with different numbers of compression slits (42, 43, 44, 45, 46, 47; 42′, 43′, 44′, 45′, 46′, 47′) that extend away from one another in a star shape.

10. Decorative film according to any of the preceding claims,
characterised in that
the number of expansion elements (50) per unit area in those regions of the decorative film (2) that can be adapted to a convex surface region (17) is greater, the smaller the radius of curvature of the convex surface region (17) is.

11. Decorative film according to any of the preceding claims,
characterised in that
the number of compression elements (40, 40′, 40″) per unit area in those regions of the decorative film (2) that can be adapted to a concave surface region (18) is greater, the smaller the radius of curvature of the concave surface region (18) is.

12. Decorative film according to any of the preceding claims,
characterised in that
the light reflection properties or light transmission properties of the decorative layer (24) can be changed by applying an electrical voltage.

13. Decorative film according to claim 12,
characterised in that
the decorative film (2) has a first electrode layer (20), a second electrode layer (22) and a decorative layer (24) arranged between the two electrode layers, the light reflection properties or light transmission properties of which can be changed by applying an electrical voltage.

14. Decorative film according to claim 13,
characterised in that
the decorative layer (24) is a smart glass LCD layer or an e-paper layer.

15. Vehicle, in particular a motor vehicle, having a vehicle body (12) and a vehicle interior (11) at least partially surrounded thereby, the vehicle body being provided with an outer body skin (10) having non-planar surface regions on the outside of the vehicle, the vehicle interior (11) having interior components that are each provided with a surface having non-planar surface regions on the inside of the vehicle,
characterised in that
the non-planar surface regions inside the vehicle and/or the non-planar surface regions outside the vehicle are provided, at least in parts, with a decorative film (2) according to any of the preceding claims which has a decorative layer (24), the light reflection properties or light transmission properties of which can preferably be changed.
